(19) United States
(12) Patent Application Publication
(10) Pub. No.: US 2012/0118334 A1
(43) Pub. Date: May 17, 2012

(54) EXHAUST GAS TREATMENT DEVICE AND METHOD AND SEMICONDUCTOR MANUFACTURING SYSTEM

(76) Inventors: Hisashi OKUCHI, Yokohama-Shi (JP); Minako Inukai, Kawasaki-Shi (JP); Hiroshi Tomita, Yokohama-Shi (JP)

(21) Appl. No.: 13/164,119

(22) Filed: Jun. 20, 2011

(30) Foreign Application Priority Data
Nov. 11, 2010 (JP) 2010-253109

(51) Int. Cl. B01D 53/14; B08B 3/02

(52) U.S. Cl. 134/95.3; 261/78.2; 95/237

(57) ABSTRACT

Certain embodiments provide an exhaust gas treatment device, comprising a scrubber unit having a vessel and a sprayer spraying water into the vessel, a first pipe through which a first gas discharged from an external apparatus and containing a non-water-soluble organic solvent is supplied to the vessel, and a second pipe through which a second gas containing a water-soluble organic solvent is supplied to the vessel through the first pipe or directly. In the vessel, the water-soluble organic solvent and the non-water-soluble organic solvent are adsorbed and removed from a mixed gas composed of the first gas and the second gas by the water sprayed from the sprayer. The mixed gas is discharged from the vessel through a third pipe.

### CROSS REFERENCE TO RELATED APPLICATION

This application is based upon and claims benefit of priority from the Japanese Patent Application No. 2010-253109, filed on Nov. 11, 2010, the entire contents of which are incorporated herein by reference.

### FIELD

Embodiments described herein relate generally to an exhaust gas treatment device, an exhaust gas treatment method, and a semiconductor manufacturing system.

### BACKGROUND

A process of manufacturing a semiconductor device includes various processes such as a lithography process, an etching process, and an ion implantation process. After the termination of each process, in order to remove impurities and residues remaining on a semiconductor substrate surface to clean the semiconductor substrate surface before proceeding to the next process, the semiconductor substrate surface is treated by cleaning and drying.

For example, in the cleaning treatment of the semiconductor substrate after the etching process, a chemical for the cleaning treatment is supplied to the semiconductor substrate surface, and thereafter purified water is supplied thereto, so that the semiconductor substrate surface is rinsed. After the rinse treatment, the purified water remaining on the semiconductor substrate surface is removed to dry the semiconductor substrate surface by the drying treatment.

As the drying treatment of the semiconductor substrate, for example, there has been known a method of replacing the purified water on the semiconductor substrate by isopropyl alcohol (IPA) and drying the semiconductor substrate. Since IPA used therein is a kind of volatile organic compound (hereinafter referred to as VOC), the amount of IPA to be discharged as a gas into atmosphere is required to be reduced in terms of environmental conservation.

As a method of suppressing the generation of a VOC gas, there has been known a method of bringing an IPA-containing exhaust gas into contact with water sprayed in mist form to make IPA to be absorbed by and transferred to water, and, thus, to purify the exhaust gas. In this conventional method, although a water-soluble organic solvent component in the exhaust gas can be removed, there is a problem that the VOC gas that contains a non-water-soluble organic solvent component and is generated in a solvent process cannot be removed by materials other than an alcohol material such as IPA.

### BRIEF DESCRIPTION OF THE DRAWINGS

FIG. 1 is a schematic configuration diagram of an exhaust gas treatment device according to a first embodiment of the present invention;

FIG. 2 is a schematic configuration diagram of an exhaust gas treatment device according to a variation; FIG. 3 is a schematic diagram for explaining the absorption of an organic solvent to a water droplet;

FIG. 4 is a schematic configuration diagram of a semiconductor manufacturing system according to a second embodiment of the present invention;

FIG. 5 is a flow chart for explaining a method of treating a semiconductor substrate surface according to the second embodiment; and

FIG. 6 is a schematic diagram for explaining a collapse force applied to a pattern on the semiconductor substrate when the semiconductor substrate is dried.

### DETAILED DESCRIPTION

Certain embodiments provide an exhaust gas treatment device, comprising a scrubber unit having a vessel and a sprayer spraying water into the vessel, a first pipe through which a first gas discharged from an external apparatus and containing a non-water-soluble organic solvent is supplied to the vessel, and a second pipe through which a second gas containing a water-soluble organic solvent is supplied to the vessel through the first pipe or directly. In the vessel, the water-soluble organic solvent and the non-water-soluble organic solvent are adsorbed and removed from a mixed gas composed of the first gas and the second gas by the water sprayed from the sprayer. The mixed gas is discharged from the vessel through a third pipe.

Hereafter, embodiments according to the present invention will be described with reference to the drawings.

### First Embodiment

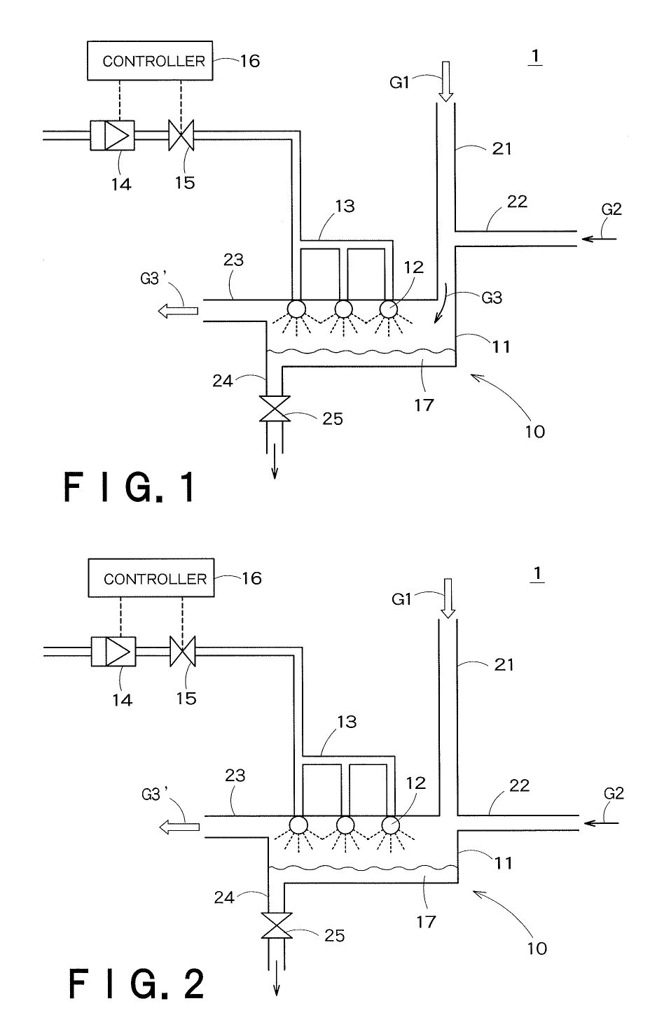

FIG. 1 shows a schematic configuration of an exhaust gas treatment device according to a first embodiment of the present invention. An exhaust gas treatment device 1 is provided with a scrubber unit 10, which brings an organic solvent-containing exhaust gas into contact with water to make the organic solvent in the exhaust gas to be absorbed by and transferred to water, a first pipe 21 and a second pipe 22 through which the exhaust gas is supplied to the scrubber unit 10, a third pipe 23 through which the exhaust gas from which the organic solvent has been removed is discharged from the scrubber unit 10, and a fourth pipe 24 through which water is discharged from the scrubber unit 10.

The scrubber unit 10 has a trap box (vessel) 11 in which the exhaust gas is supplied through the first pipe 21 and the second pipe 22 and discharged through the third pipe 23, and sprayers 12 which spray water in the trap box 11. Water (for example, industrial water) is supplied to the sprayers 12 through a fifth pipe 13. The fifth pipe 13 is provided with a flowmeter 14 which measures the flow of water and a valve 15 which adjusts the flow of water. The scrubber unit 10 is further provided with a controller 16 which controls the openness of the valve 15 based on the amount of the exhaust gas supplied to the trap box 11 and the measured value of the flowmeter 14.

The trap box 11 has a receiving tray 17 provided at the lower portion, and water sprayed from the sprayer 12 can be temporarily stored in the receiving tray 17. The water stored in the receiving tray 17 is discharged through the fourth pipe 24. The fourth pipe 24 is provided with a valve 25, and the amount of water discharged from the trap box 11 can be regulated by the valve 25.

The first pipe 21 supplies an exhaust gas (hereinafter referred to as a first gas) G1, containing a non-water-soluble organic solvent discharged from an external apparatus (not shown), to the trap box 11. Examples of the non-water-soluble organic solvent component include toluene, benzene, xylene, cyclohexane, cyclohexanone, cyclohexanol, formaldehyde, tetramethyl silyl diethylamine (TMSDEA), and propylene glycol monomethyl ether acetate (PGMEA).

The second pipe 22 supplies an exhaust gas (hereinafter referred to as a second gas) G2, containing a water-soluble organic solvent discharged from an external apparatus (not shown), to the trap box 11. The water-soluble organic solvent includes alcohols such as ethanol, isopropyl alcohol, and n-propyl alcohol, a water-soluble first class petroleum such as acetone, a water-soluble second class petroleum such as acetic acid, and a water-soluble third class petroleum such as ethylene glycol.

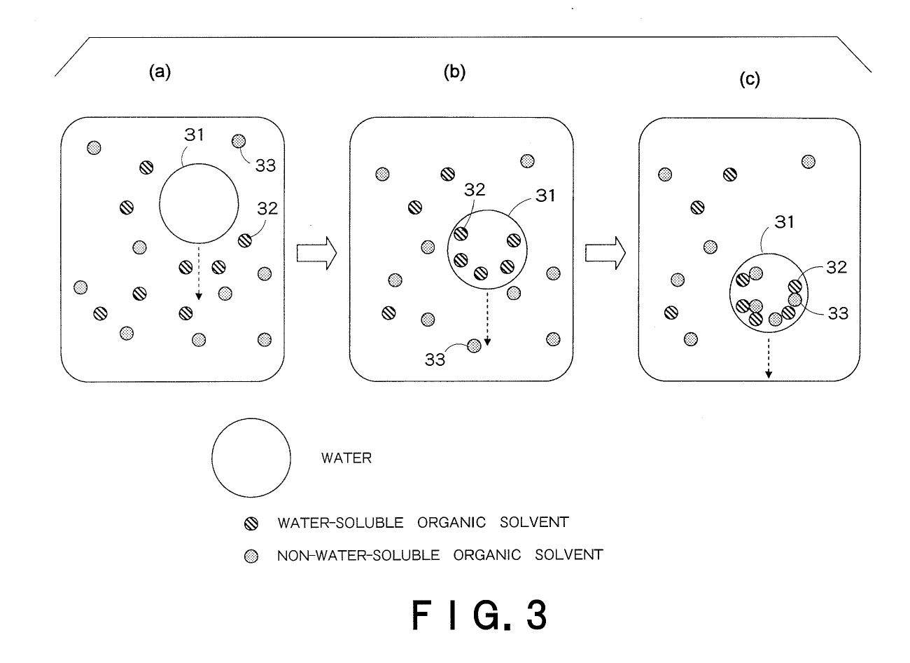

In FIG. 1, the second pipe 22 is connected to the first pipe 21, and a mixed gas G3 composed of the first gas G1 and the second gas G2 is supplied to the trap box 11. However, as shown in FIG. 2, the second pipe 22 is directly connected to the trap box 11, and the first gas G1 and the second gas G2 may be mixed in the trap box 11.

The third pipe 23 is provided on the opposite side of the first pipe 21 and the second pipe 22 so that the sprayers 12 are provided between the third pipe 23, and the first pipe 21 and the second pipe 22. According to this constitution, the third pipe 23 can discharge a mixed gas G3′ (Non VOC gas) in which a non-water-soluble organic solvent and a water-soluble organic solvent have been adsorbed and removed after bringing the mixed gas G3 into contact with water sprayed from the sprayers 12.

The first pipe 21 and the second pipe 22 may be provided with a pump (not shown) for supplying a gas to the trap box 11. Further, the third pipe 23 may be provided with a pump (not shown) for drawing a gas from the trap box 11.

In the trap box 11 of the scrubber unit 10, water is sprayed to the third gas G3 composed of the first gas G1 and the second gas G2, from the sprayer 12. The water is sprayed in mist form, whereby a contact area between the water and a gas phase is increased, and the organic solvent (water-soluble organic solvent and non-water-soluble organic solvent) in the mixed gas can be absorbed to water droplets (water mist).

The absorption of the organic solvent to water droplets will be described using FIG. 3. As shown in FIG. 3(a), a water droplet 31 sprayed from the sprayer 12 is in contact with water-soluble organic solvents 32 and non-water-soluble organic solvents 33 in a mixed gas while moving down in the trap box 11.

The water-soluble organic solvent 32 has both a hydrophilic group and a lipophilic group. For example, alcohols have a lipophilic alkyl group and a hydrophilic hydroxyl group. As another example, acetone has a lipophilic methyl group and a hydrophilic carbonyl group. As still another example, acetic acid has a lipophilic methyl group and a hydrophilic carboxyl group. By virtue of the hydrophilic group contained in the water-soluble organic solvent 32, the water-soluble organic solvent 32 has an affinity for water, and as shown in FIG. 3(b), the water-soluble organic solvents 32 are absorbed to the water droplet 31.

In the water droplet 31 absorbed the water-soluble organic solvents 32, the affinity for the lipophilic group (alkyl group) of the non-water-soluble organic solvent 33 is enhanced by the hydrophilic group contained in the water-soluble organic solvent 32. Therefore, as shown in FIG. 3(c), the non-water-soluble organic solvent 33 is absorbed to the water droplet 31 absorbed the water-soluble organic solvent 32. In this manner, one water droplet 31 can absorb both the water-soluble organic solvent 32 and the non-water-soluble organic solvent 33.

The water droplet 31 to which the water-soluble organic solvent 32 and the non-water-soluble organic solvent 33 are absorbed is moved down by gravity to be temporarily stored in the receiving tray 17. Thereafter, water in the receiving tray 17 is discharged through the fourth pipe 24.

The mixed gas G3′ in which the water-soluble organic solvent and the non-water-soluble organic solvent have been adsorbed and removed by the water sprayed from the sprayers 12 is discharged from the trap box 11 through the third pipe 23.

As described above, in the present embodiment, in order to remove the non-water-soluble organic solvent from the first gas G1 containing the non-water-soluble organic solvent, the second gas G2 containing the water-soluble organic solvent is mixed, and the water-soluble organic solvent is absorbed to the water droplet, whereby the non-water-soluble organic solvent can also be absorbed to the same water droplet. Thus, the non-water-soluble organic solvent component in an exhaust gas can be removed only by a water scrubber, and the generation of the VOC gas can be suppressed.

In the above embodiment, it is preferable that the mixing ratio (gas flow ratio) between the first gas G1 containing the non-water-soluble organic solvent and the second gas G2 containing the water-soluble organic solvent is previously set based on the affinity between the non-water-soluble organic solvent to be removed and the water-soluble organic solvent so that the mixing ratio is a suitable ratio.

Further, it is preferable that the sprayed amount from the sprayer 12 is determined based on an air volume, the mixing ratio between the non-water-soluble organic solvent and the water-soluble organic solvent, a target value of an organic solvent concentration in the mixed gas G3′ discharged from the third pipe 23, and so on, and is controlled by the controller 16.

### Second Embodiment

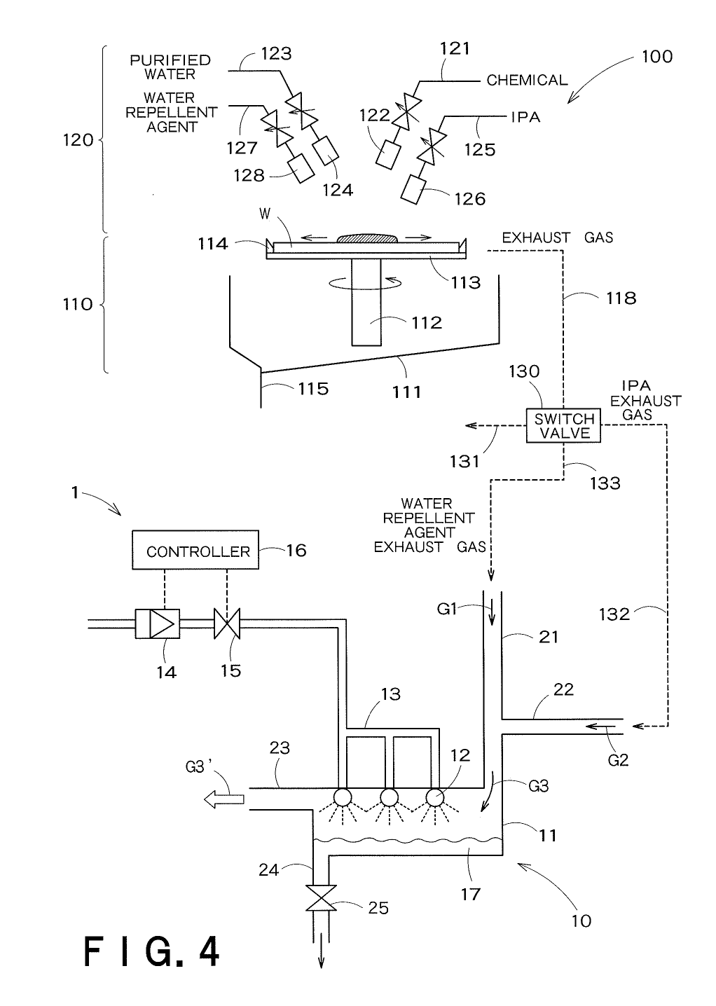

FIG. 4 shows a schematic configuration of a semiconductor manufacturing system according to a second embodiment of the present invention. As shown in FIG. 4, the semiconductor manufacturing system is provided with a surface treatment device 100 which performs surface treatment of a semiconductor substrate and an exhaust gas treatment device 1 which treats an exhaust gas discharged from the surface treatment device 100. The exhaust gas treatment device 1 has a constitution similar to that of the exhaust gas treatment device 1 shown in FIG. 1. In FIG. 4, the same components as those of the first embodiment shown in FIG. 1 are assigned the same reference numerals, and the description will be omitted.

First, the surface treatment device 100 will be described. As shown in FIG. 4, the surface treatment device 100 is provided with a substrate holding rotating unit 110 and a liquid supply unit 120 and cleans and dries a semiconductor substrate W. The substrate holding rotating unit 110 has a spin cup 111 constituting a treatment chamber, a rotation shaft 112, a spin base 113, and a chuck pin 114. The rotation shaft 112 extends in an approximately vertical direction, and the spin base 113 having a disk shape is attached to the upper end of the rotation shaft 112. The rotation shaft 112 and the spin base 113 can be rotated by a motor (not shown).

The chuck pin 114 is provided at a peripheral edge of the spin base 113. The chuck pin 114 holds the semiconductor substrate W, whereby the substrate holding rotating unit 110 can rotate the substrate W while holding the substrate W substantially horizontally.

When a liquid is supplied near the rotation center of the surface of the semiconductor substrate W from the liquid supply unit 120, the liquid is spread in the radial direction of the semiconductor substrate W. The substrate holding rotating unit 110 can perform spin-drying of the semiconductor substrate W. The excess liquid scattered in the radial direction of the semiconductor substrate W is caught by the spin cup 111 to be discharged through a pipe 115.

The liquid supply unit 120 can supply a medical solution, purified water, IPA, and a water repellent agent to the surface of the semiconductor substrate W. In a first supply section of the liquid supply unit 120, the chemical is supplied through a supply line 121 to be ejected from a nozzle 122. The chemical is SPM (Sulfuric acid Hydrogen Peroxide Mixture: a mixed solution composed of sulfuric acid and hydrogen peroxide solution), for example.

Likewise, in a second supply section of the liquid supply unit 120, purified water is supplied through a supply line 123 to be ejected from a nozzle 124. In a third supply section of the liquid supply unit 120, IPA is supplied through a supply line 125 to be ejected from a nozzle 126.

Also, in a forth supply section of the liquid supply unit 120, a water repellent agent is supplied through a supply line 127 to be ejected from a nozzle 128. The water repellent agent is a chemical that forms a water-repellent protective film on a convex shaped pattern surface formed on the surface of the semiconductor substrate W to render the pattern surface water-repellent. As the water repellent agent, a silane coupling agent is used, for example. The silane coupling agent has in its molecule a hydrolytic group having the affinity and reactivity with an inorganic material and an organic functional group having the affinity for an organic material, and, for example, tetramethyl silyl diethylamine (TMSDEA) and the like may be used as the silane coupling agent.

The surface treatment device 100 is provided with an excimer UV (ultraviolet) irradiation unit (not shown). The excimer UV irradiation unit irradiates the semiconductor substrate W with UV light and can remove the water-repellent protective film while remaining the convex shaped pattern. As a method other than the UV-light irradiation, a removal unit, which removes the water-repellent protective film while remaining the convex shaped pattern, may be provided.

A treatment chamber of the substrate holding rotating unit 110 has a supplying/discharging function. Exhaust gas in the treatment chamber is discharged through a discharge line 118, and a flow path is switched by a switch valve 130. For example, a four-way valve is used as the switch valve 130. The flow path is switched by the switch valve 130 so that exhaust gas of a chemical such as SPM flows through a pipe 131, exhaust gas of IPA flows through a pipe 132, and exhaust gas of a water repellent agent flows through a pipe 133. The pipe 133 is connected to a first pipe 21 of the exhaust gas treatment device 1. The pipe 132 is connected to a second pipe 22 of the exhaust gas treatment device 1.

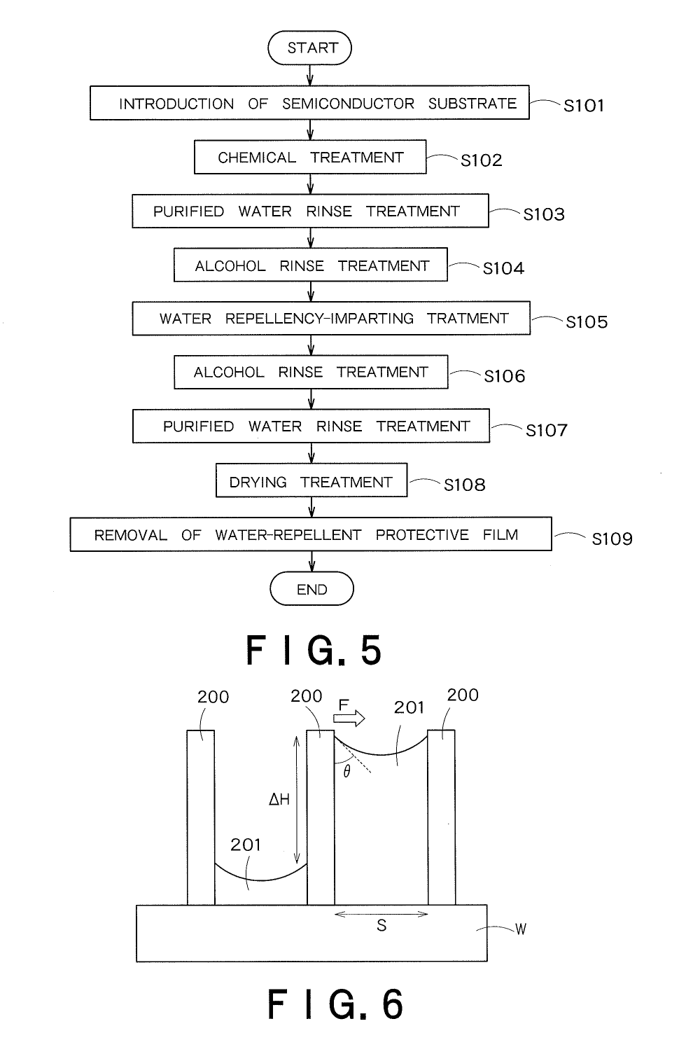

Next, a method of treating a semiconductor substrate surface by using the surface treatment device 100 will be described using a flow chart shown in FIG. 5. The operation of the substrate holding rotating unit 110 and the liquid supply unit 120 can be controlled by a controller (not shown).

### Step S101

The semiconductor substrate W to be treated is conveyed by a conveyer (not shown) to be held by the substrate holding rotating unit 110. A plurality of convex shaped patterns are formed on a predetermined region of the surface of the semiconductor substrate W. The convex shaped pattern is a line-and-space pattern, for example. At least a part of the convex shaped pattern may be formed of a silicon-containing film. The convex shaped pattern is formed by RIE (Reactive Ion Etching), for example.

### Step S102

The semiconductor substrate W is rotated at a predetermined rotation speed, and a chemical is supplied near the rotation center of the surface of the semiconductor substrate W from the nozzle 122 of the liquid supply unit 120. Examples of the chemical include SPM, SC-1 (Standard Clean 1), SC-2 (Standard Clean 2), HF and the like. One or plural kinds of medical solutions may be simultaneously or continuously supplied.

The chemical employing the centrifugal force by the rotation of the semiconductor substrate W is applied across the entire surface of the semiconductor substrate W, whereby a chemical (cleaning) treatment of the semiconductor substrate W is performed.

### Step S103

After the chemical treatment, purified water is supplied near the rotation center of the surface of the semiconductor substrate W from the nozzle 124 of the liquid supply unit 120. The purified water employing the centrifugal force by the rotation of the semiconductor substrate W is applied across the entire surface of the semiconductor substrate W. According to this constitution, the chemical remaining on the surface of the semiconductor substrate W is rinsed with the purified water by a purified water rinse treatment.

### Step S104

After the purified water rinse treatment, alcohol such as IPA is supplied near the rotation center of the surface of the semiconductor substrate W from the nozzle 126 of the liquid supply unit 120. IPA employing the centrifugal force by the rotation of the semiconductor substrate W is applied across the entire surface of the semiconductor substrate W. According to this constitution, the purified water remaining on the surface of the semiconductor substrate W is replaced by IPA by an alcohol rinse treatment.

### Step S105

After the alcohol rinse treatment, a water repellent agent is supplied near the rotation center of the surface of the semiconductor substrate W from the nozzle 128 of the liquid supply unit 120. The water repellent agent is a silane coupling agent, for example.

The silane coupling agent employing the centrifugal force by the rotation of the semiconductor substrate W is applied across the entire surface of the semiconductor substrate W. According to this constitution, a water repellency-imparting treatment is performed to form a protective film with low wettability (water repellent protective film) on the convex shaped pattern surface. The water repellent protective film is formed by an ester reaction of a silane coupling agent.

### Step S106

After the water repellency-imparting treatment, IPA is supplied near the rotation center of the surface of the semiconductor substrate W from the nozzle 126 of the liquid supply unit 120. IPA employing the centrifugal force by the rotation of the semiconductor substrate W is applied across the entire surface of the semiconductor substrate W. According to this constitution, an unreacted silane coupling agent remaining on the surface of the semiconductor substrate W is replaced by IPA by the alcohol rinse treatment.

### Step S107

After the alcohol rinse treatment of step S106, purified water is supplied near the rotation center of the surface of the semiconductor substrate W from the nozzle 124 of the liquid supply unit 120. The purified water employing the centrifugal force by the rotation of the semiconductor substrate W is applied across the entire surface of the semiconductor substrate W. According to this constitution, IPA remaining on the surface of the semiconductor substrate W is rinsed with the purified water by the purified water rinse treatment.

### Step S108

After the purified water rinse treatment of step S107, the semiconductor substrate W is dried. For example, a spin-dry treatment is performed to increase the rotation speed of the semiconductor substrate W to a predetermined spin-dry rotation speed, and, thus, to shake off the purified water remaining on the surface of the semiconductor substrate W, whereby the semiconductor substrate W is dried.

Since the convex shaped pattern formed on the semiconductor substrate W is covered by the water-repellent protective film, a contact angle θ of a liquid increases (to close to) 90°.

A collapse force, which is applied to the pattern formed on the semiconductor substrate W when the semiconductor substrate W is dried, will be described using FIG. 6. FIG. 6 shows a state that a part of a pattern 200 formed on the semiconductor substrate W is wet with a liquid 201. When a distance between the patterns 200 is S, a difference of height of a liquid surface between the liquids 201 on the both sides of the pattern 200 is ΔH, a surface tension of the liquid 201 is γ, and a contact angle is θ, a collapse force F applied to the pattern 200 is F=2×γ×ΔH×cosθ/S. When the contact angle θ is close to 90°, cosθ is close to 0, and it is shown that the collapse force F is reduced. Accordingly, the convex shaped pattern surface is covered by the water-repellent protective film, whereby the convex shaped pattern can be prevented from being collapsed in the drying treatment.

### Step S109

After the drying treatment, by irradiation of ultraviolet ray from the excimer UV irradiation unit, the water-repellent protective film formed on the convex shaped pattern surface is removed.

As described above, the semiconductor substrate W can be cleaned and dried while preventing the convex shaped pattern formed on the semiconductor substrate W from collapsing, with the use of the surface treatment device 100.

Subsequently, the treatment of the exhaust gas discharged from the surface treatment device 100 and containing a water repellent agent, when the semiconductor substrate W is cleaned and dried using the surface treatment device 100 described above, will be described.

Exhaust gas (water repellent agent exhaust gas) from the treatment chamber in the water repellency-imparting treatment of step S105 is supplied to the trap box 11 through the discharge line 118, the pipe 133, and the first pipe 21 of the exhaust gas treatment device 1, shown in FIG. 4. Meanwhile, exhaust gas (IPA exhaust gas) from the treatment chamber in the alcohol rinse treatment of steps S104 and S106 is supplied to the trap box 11 through the discharge line 118, the pipe 132, and the second pipe 22 and the first pipe 21 of the exhaust gas treatment device 1. Namely, the water repellent agent exhaust gas in the pipe 133 corresponds to the first gas G1 containing the non-water-soluble organic solvent, and the IPA exhaust gas in the pipe 132 corresponds to the second gas G2 containing the water-soluble organic solvent.

As described in the first embodiment, the mixed gas G3 composed of the first gas G1 and the second gas G2 is in contact with the water droplets sprayed from the sprayers 12 in the trap box 11, whereby IPA (water-soluble organic solvent) in the mixed gas G3 is absorbed to the water droplets. Since the affinity of the water droplet absorbing IPA for a lipophilic group of the non-water-soluble organic solvent is enhanced, the water droplet absorbs the water repellent agent (non-water-soluble organic solvent) in the mixed gas G3.

The water droplet to which IPA and the water repellent agent are absorbed is moved down by gravity to be temporarily stored in the receiving tray 17 and thereafter discharged through the fourth pipe 24.

Meanwhile, the mixed gas G3′ in which the IPA component and the water repellent agent component have been absorbed and removed therefrom by the water sprayed from the sprayers 12 is discharged from the trap box 11 through the third pipe 23.

As described above, in the semiconductor manufacturing system according to the present embodiment, in the exhaust gas treatment device 1, in order to remove the water repellent agent from the exhaust gas discharged from the surface treatment device 100 and containing the water repellent agent, an IPA-containing exhaust gas is mixed, and IPA is absorbed to the water droplet, whereby the water repellent agent can also be absorbed to the same water droplet. Thus, the water repellent agent component in the exhaust gas is removed only by the water scrubber, and the generation of the VOC gas can be suppressed. Further, since a new power usage other than a scrubber water is not required to be used, equipment cost can be suppressed.

In the second embodiment, although the exhaust gas containing the water repellent agent component and the exhaust gas containing the IPA component are separately supplied (switching to each other) to the exhaust gas treatment device 1, the exhaust gas of the surface treatment device 100 that contains both the water repellent agent component and the IPA component may be supplied to the trap box 11. For example, the exhaust gas containing both the water repellent agent component and the IPA component is removed from the upstream side of the switch valve 130, that is, the discharge line 118, and the removed exhaust gas can be supplied to the trap box 11. When the amount of the IPA component contained in the exhaust gas flowing through the discharge line 118 is small, an IPA-containing exhaust gas discharged from another equipment such as a clean room may be supplied to the trap box 11.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An exhaust gas treatment device, comprising:
a scrubber unit including a vessel and a sprayer spraying water into the vessel;
a first pipe through which a first gas discharged from an external apparatus and containing a non-water-soluble organic solvent is supplied to the vessel;
a second pipe through which a second gas containing a water-soluble organic solvent is supplied to the vessel through the first pipe or directly; and
a third pipe through which a mixed gas composed of the first gas and the second gas, the water-soluble organic solvent and the non-water-soluble organic solvent being adsorbed and removed therefrom by the water sprayed from the sprayer in the vessel, is discharged from the vessel.

2. The exhaust gas treatment device according to claim 1, further comprising a controller controlling the amount of the water, sprayed from the sprayer, based on the supply of the first gas and the second gas to the vessel.

3. The exhaust gas treatment device according to claim 1, further comprising a fourth pipe through which water absorbing the water-soluble organic solvent and the non-water-soluble organic solvent from the mixed gas is discharged from the vessel.

4. The exhaust gas treatment device according to claim 1, wherein the non-water-soluble organic solvent is toluene, benzene, xylene, cyclohexane, cyclohexanone, cyclohexanol, formaldehyde, tetramethyl silyl diethylamine, or propylene glycol monomethyl ether acetate, and the water-soluble organic solvent is alcohol or water-soluble petroleum.

5. The exhaust gas treatment device according to claim 4, wherein the alcohol is methanol, ethanol, isopropyl alcohol, or n-propyl alcohol, and the water-soluble petroleum is acetone, pyridine, acetic acid, propionic acid, acrylic acid, ethylene glycol, or glycerin.

6. An exhaust gas treatment method, comprising:
spraying water to a mixed gas mixed a first gas containing a non-water-soluble organic solvent with a second gas containing a water-soluble organic solvent, by a sprayer, in a vessel; and
discharging the mixed gas being in contact with the sprayed water, from the vessel.

7. The exhaust gas treatment method according to claim 6, wherein the amount of the water to spray is controlled based on the flow of the first gas and the second gas.

8. The exhaust gas treatment method according to claim 6, wherein water absorbing the water-soluble organic solvent and the non-water-soluble organic solvent from the mixed gas is discharged.

9. The exhaust gas treatment method according to claim 6, wherein the non-water-soluble organic solvent is toluene, benzene, xylene, cyclohexane, cyclohexanone, cyclohexanol, formaldehyde, tetramethyl silyl diethylamine, or propylene glycol monomethyl ether acetate, and the water-soluble organic solvent is alcohol or water-soluble petroleum.

10. The exhaust gas treatment method according to claim 9, wherein the alcohol is methanol, ethanol, isopropyl alcohol, or n-propyl alcohol, and the water-soluble petroleum is acetone, pyridine, acetic acid, propionic acid, acrylic acid, ethylene glycol, or glycerin.

11. A semiconductor manufacturing system, comprising:
a surface treatment device including
a substrate holding rotating unit holding a semiconductor substrate with a convex shaped pattern formed on the surface and rotating the semiconductor substrate,
a first supply unit supplying a chemical to the surface of the semiconductor substrate held by the substrate holding rotating part and cleaning the semiconductor substrate,
a second supply unit supplying purified water to the surface of the semiconductor substrate held by the substrate holding rotating unit and rinsing the semiconductor substrate,
a third supply unit supplying alcohol to the surface of the semiconductor substrate held by the substrate holding rotating unit and rinsing the semiconductor substrate, and
a fourth supply unit supplying a water repellent agent to the surface of the semiconductor substrate held by the substrate holding rotating unit and forming a water-repellent protective film on the surface of the convex shaped pattern; and
an exhaust gas treatment device including
a scrubber unit including a vessel and a sprayer spraying water into the vessel,
a first pipe through which a first gas containing the water repellent agent discharged from the surface treatment device is supplied to the vessel,
a second pipe through which a second gas containing the alcohol discharged from the surface treatment device is supplied to the vessel through the first pipe or directly, and
a third pipe through which a mixed gas composed of the first gas and the second gas, the alcohol and the water repellent agent being adsorbed and removed therefrom by the water sprayed from the sprayer in the vessel, is discharged from the vessel.

12. The semiconductor manufacturing system according to claim 11, further comprising a controller controlling the amount of the water, sprayed from the sprayer, based on the supply of the first gas and the second gas to the vessel.

13. The semiconductor manufacturing system according to claim 11, further comprising a fourth pipe through which water absorbing the water-soluble organic solvent and the non-water-soluble organic solvent from the mixed gas is discharged from the vessel.

14. The semiconductor manufacturing system according to claim 11, further comprising a pipe through which an alcohol-containing gas discharged from another equipment is supplied to the vessel.
